(19) United States
(12) Patent Application Publication
(10) Pub. No.: US 2025/0030461 A1
(43) Pub. Date: Jan. 23, 2025

(54) PASSIVE IOT ILLUMINATION POWER SETTING

(71) Applicant: Nokia Solutions and Networks Oy, Espoo (FI)

(72) Inventors: Tzu-Chung HSIEH, Naperville, IL (US); Muhammad Majid BUTT, Naperville, IL (US); Navin HATHIRAMANI, Dallas, TX (US)

(21) Appl. No.: 18/762,320

(22) Filed: Jul. 2, 2024

(30) Foreign Application Priority Data
Jul. 20, 2023 (GB) 2311098.4

(51) Int. Cl. H04B 7/0426; G01S 17/86; H04B 7/06; H04B 17/309

(52) U.S. Cl. CPC H04B 7/043; G01S 17/86; H04B 7/06952; H04B 17/347

(57) ABSTRACT

An apparatus comprising: means for receiving a proximity pathloss threshold from a network, wherein a pathloss between a passive device and a user equipment connected to the apparatus is less than the proximity pathloss threshold; means for receiving, from the user equipment, at least one measurement associated with the user equipment; means for determining a backscatter link beam direction, based at least on the at least one measurement associated with the user equipment; and means for determining an illumination power of an illumination transmission to the passive device, based at least on the proximity pathloss threshold.

### TECHNICAL FIELD

The examples and non-limiting example embodiments relate generally to communications and, more particularly, to passive internet of things (IoT) illumination transmission and power setting.

### BACKGROUND

It may be useful to implement passive devices not having a power and energy source in a communication network, for applications such as inventory tracking.

### SUMMARY

In accordance with an aspect, an apparatus includes: means for receiving a proximity pathloss threshold from a network, wherein a pathloss between a passive device and a user equipment connected to the apparatus is less than the proximity pathloss threshold; means for receiving, from the user equipment, at least one measurement associated with the user equipment; means for determining a backscatter link beam direction, based at least on the at least one measurement associated with the user equipment; and means for determining an illumination power of an illumination transmission to the passive device, based at least on the proximity pathloss threshold.

The apparatus may further include: means for receiving, from the user equipment, a report that indicates a beam of the user equipment having a higher reference signal received power than at least one other beam of the user equipment; and means for determining the backscatter link beam direction, based on a direction of the beam of the user equipment having a higher reference signal received power than at least one other beam of the user equipment.

The apparatus may further include: means for determining the backscatter link beam direction, based on a reference signal received power of a first beam of the user equipment and a reference signal received power of a neighbor beam of the user equipment; wherein the reference signal received power of the first beam is higher than a reference signal received power of at least one neighbor beam of the user equipment including the neighbor beam.

The apparatus may further include: means for determining whether a distance between the user equipment and an edge of the first beam is less than or equal to a distance threshold; and means for determining the backscatter link beam direction, based on the reference signal received power of the first beam of the user equipment and the reference signal received power of the neighbor beam of the user equipment, when the distance between the user equipment and the edge of the first beam is less than or equal to the distance threshold.

The apparatus may further include: means for determining a first angle based on the first beam, means for determining a difference between the reference signal received power of the first beam and the reference signal received power of the neighbor beam; means for determining a correction angle to apply to the first angle, based on the difference; and means for determining the backscatter link beam direction, based on the correction angle applied to the first angle; wherein the first angle and the correction angle are in an azimuth domain or an elevation domain.

The apparatus may further include: means for determining a first angle based on the first beam; means for determining location information associated with the user equipment; means for determining a correction angle to apply to the first angle, based on the location information associated with the user equipment; and means for determining the backscatter link beam direction, based on the correction angle applied to the first angle; wherein the first angle and the correction angle are in an azimuth domain or an elevation domain.

The apparatus may further include: means for determining a pathloss between the apparatus and the user equipment, based on a reference signal received power of the user equipment; means for determining a pathloss between the apparatus and the passive device, based at least on the pathloss between the apparatus and the user equipment; and means for determining the illumination power based at least partially on the pathloss between the apparatus and the passive device.

The apparatus may further include: means for determining a coefficient based on at least one known backscatter link characteristic and a reference signal power density; and means for determining the illumination power, based on the coefficient.

The apparatus may further include wherein the at least one known backscatter link characteristic comprises at least one of: a sensitivity of a reader of a backscatter signal, or an antenna gain of the passive device, or a backscatter modulation factor.

The apparatus may further include: means for determining the coefficient at least based on the sensitivity of the reader of the backscatter signal, the antenna gain of the passive device, and the backscatter modulation factor.

The apparatus may further include: means for determining a reference signal received power of the user equipment; and means for determining the illumination power at least partially based on the reference signal received power.

The apparatus may further include: means for determining, when the passive device has no energy storage, a received power threshold of the passive device, such that a carrier wave arrives at the passive device with a power greater than the received power threshold.

The apparatus may further include: means for determining a first coefficient based on at least one known backscatter link characteristic and a reference signal power density; means for determining a reference signal received power of the user equipment; means for determining a second coefficient based at least on the received power threshold of the passive device and one known backscatter link characteristic; and means for determining the illumination power based on the first coefficient, the reference signal received power, and the second coefficient.

The apparatus may further include: means for determining a difference between the first coefficient and the reference signal received power; means for determining the illumination power based on the proximity pathloss threshold added to a larger of the difference and the second coefficient, when the user equipment performs the illumination transmission to the passive device.

The apparatus may further include: means for determining the second coefficient based on an antenna gain of the user equipment and an antenna gain of the passive device, wherein the one known backscatter link characteristic comprises the antenna gain of the passive device.

The apparatus may further include: means for determining a sum comprising the first coefficient added to the proximity pathloss threshold; means for determining the illumination power based on the reference signal received power subtracted from a larger of the sum and the second coefficient, when the apparatus performs the illumination transmission to the passive device.

The apparatus may further include: means for determining the second coefficient based on the reference signal power density, an antenna gain of the user equipment, and an antenna gain of the passive device, wherein the one known backscatter link characteristic comprises the antenna gain of the passive device.

The apparatus may further include: means for storing a used illumination power, a reference signal received power of a user equipment, and a beam selection of a user equipment in a database; and means for retrieving from the database at least one of: the used illumination power, or the reference signal received power of the user equipment, or the beam selection of the user equipment; wherein the illumination power of the illumination transmission to the passive device is determined based on at least one of the used illumination power, or the reference signal received power of the user equipment, or the beam selection of the user equipment retrieved from the database.

The apparatus may further include: means for determining whether a backscatter signal was received; wherein the used illumination power, or the reference signal received power of the user equipment, or the beam selection of a user equipment is stored in the database when the backscatter signal was received.

The apparatus may further include: means for determining whether the passive device is stationary; wherein the used illumination power, or the reference signal received power of the user equipment, or the beam selection of a user equipment is stored in the database when the passive device is stationary.

In accordance with an aspect, an apparatus includes: means for receiving, from a network node, a first scheduled time of a first illumination transmission to a passive device; means for performing the first illumination transmission to the passive device at the first scheduled time with a first illumination power; means for receiving, from the network node, a second scheduled time of a second illumination transmission to the passive device; and means for performing the second illumination transmission to the passive device at the second scheduled time with a second illumination power; wherein the second illumination power is greater than the first illumination power.

The apparatus may further include: means for determining the first illumination power and the second illumination power.

The apparatus may further include: means for receiving, from the network node, the first illumination power; and means for receiving, from the network node, the second illumination power.

### BRIEF DESCRIPTION OF THE DRAWINGS

The foregoing aspects and other features are explained in the following description, taken in connection with the accompanying drawings.

FIGS. 1A and 1B depict a new radio network node (gNB) and a user equipment (UE) in a bi-static passive internet of things (IoT) architecture.

FIG. 2 depicts illumination and backscatter signal paths.

FIG. 3 shows a backscatter beam direction estimate from two new radio (NR) beams.

FIG. 4A is a process diagram for the case where the gNB illuminates and the UE receives the backscatter signal.

FIG. 4B is a signaling flow chart for the case where the gNB illuminates and the UE receives the backscatter signal.

FIG. 5A is a process diagram for the case where the UE illuminates and the gNB receives the backscatter signal, and illumination power is determined by the gNB.

FIG. 5B is a signaling flow chart for the case where the UE illuminates and the gNB receives the backscatter signal, and illumination power is determined by the gNB.

FIG. 6A shows a process diagram for the case where the UE illuminates and the gNB receives the backscatter signal, and illumination power is determined by the UE.

FIG. 6B is a signaling flow chart for the case where the UE illuminates and the gNB receives the backscatter signal, and illumination power is determined by the UE.

FIG. 7 is a block diagram of an example system in which the example embodiments may be practiced;

FIG. 8 illustrates an example apparatus configured to implement the examples described herein;

FIG. 9 illustrates example implementations of non-volatile memory media used to store instructions that implement the examples described herein;

FIG. 10 illustrates an example method, based on the examples described herein;

FIG. 11 illustrates an example method, based on the examples described herein;

FIG. 12 illustrates an example method, based on the examples described herein; and

FIG. 13 illustrates an example method, based on the examples described herein.

### DETAILED DESCRIPTION

A wireless sensor network (WSN) is essential for the digitalization and automation of industry and society. Data related to environment, inventory, production, health, traffic, etc., are collected by sensors and transmitted by wireless devices in a WSN. Future systems and applications require massive deployment of sensors and IoT devices which are self-sustainable and maintenance free. Ambient IoT technology is quickly developing to enable IoT devices to harvest energy from ambient sources, e.g., radio waves, light, motion, heat, etc., and operate without replaceable or rechargeable battery.

The third generation partnership project (3GPP) has identified ambient IoT use cases, service requirements, and performance key performance indicators (KPIs) in technical report (TR) 22.840 [3GPP TR 22.840, Study on Ambient power-enabled Internet of Things], and is currently studying ambient IoT deployment scenarios and design targets within the 3GPP radio access systems [RP-223396, SID revised: Study on Ambient IoT, 3GPP TSG RAN #98e]. The ambient IoT connection and device density can be orders-of-magnitude higher than the existing 3GPP low-power, wide-area (LPWA) technologies such as narrowband internet of things (NB-IoT) and long term evolution machine type communication (LTE-MTC), while the device complexity and power consumption can be orders-of-magnitude lower. The study considers Ambient IoT deployment in-band to NR, in guard-band of NR, and in standalone band from NR. [RP-230801, Results of offline discussions on ambient IoT, 3GPP TSG RAN #99].

● Topology (1): BS <−> Ambient IoT device

| | |
|---|---|
| ◯ | NOTE 1: Includes the possibility of BS Rx and BS Tx in different BSs |

● Topology (2): BS <−> intermediate node <−> Ambient IoT device

| | |
|---|---|
| ◯ | NOTE 1: Intermediate node can be relay, IAB, UE, repeater, etc. which is |
| | capable of ambient IoT |

● Topology (3): BS <−> assisting node <−> Ambient IoT device <−> BS

| | |
|---|---|
| ◯ | NOTE 1: Assisting node can be relay, IAB, UE, repeater, etc. which is |
| | capable of ambient IoT |
| ◯ | FFS: If the two BS can be different |

● Topology (4): UE <−> Ambient IoT device
● FFS: Topology (5) UE <−> Ambient IoT device <−> {BS or UE}
NOTE: For potential topology (5), discuss its relation with other topologies, its necessity,
etc. in RAN#99.
NOTE for all topologies: The Ambient IoT device may be provided with carrier wave
from another node(s) either inside or outside the topology
NOTE for all topologies: The links in each topology may be bidirectional or
unidirectional
FFS: Whether to consider combination of different topologies in the study.
FFS: BS, UE, or assisting node could be multiple BSs, UEs or assisting nodes,
respectively.

IAB refers to integrated access and backhaul, FFS refers to for further study, and RAN #refers to a radio access network (RAN) meeting.

Currently three classes of Ambient IoT devices are being defined in 3GPP, Device A, Device B, and Device C.

Device A: No energy storage, no independent signal generation, i.e. backscattering transmission.

Device B: Has energy storage, no independent signal generation, i.e. backscattering transmission. Use of stored energy can include amplification for reflected signals.

Device C: Has energy storage, has independent signal generation, i.e. active RF component for transmission.

Device A is the simplest class consuming the lowest power, while Device C is the most complex and consumes the highest power. The power consumption while transmitting and receiving may be in the order of 1 W or 10 W for Device A and under 1 mW or 10 mW for Device C. Device A may be as simple as a radio frequency identification (RFID) tag, and even Device C has a complexity orders-of-magnitude below NB-IoT.

Device A and Device B classes are passive IoT devices without active radio frequency (RF) components, e.g., local oscillator, power amplifier, typically used in wireless communications. These passive devices rely on an external carrier wave to excite their circuit and modulate the reflected wave with the device's information bits. RFID is an example of passive devices communicating via backscatter modulation. The passive device can harvest energy either directly from the incident excitation carrier while modulating (as Device A), or from other ambient energy sources and save the energy in a capacitor (as Device B). Thereby, they can both be self-sustainable without battery.

The ongoing effort in 3GPP is striving to extend the range of passive IoT beyond the limit of RFID and enable the massive connections of ultra-low complexity, energy harvesting ambient IoT devices.

In LTE and NR, UE must follow power control procedure [3GPP TS 36.213, Physical layer procedures (LTE)][3GPP TS 38.213, Physical layer procedures for control (NR)] during the initial access and in the connected mode when transmit uplink signal. The uplink (UL) power control mechanism mitigates the co-channel interference to other UEs in the cell and in other cells.

Unlike a user equipment (UE) in the LTE or NR system, passive IoT devices do not have an active transceiver to communicate directly with a base station (BS). They rely on an illumination signal carrier to modulate information in the backscattered signal. That illumination signal may be originated from a gNB (base station in NR) or from a UE or other intermediate node. The illumination signal power setting must consider passive IoT and backscatter link characteristics, which are lacking in the prior art.

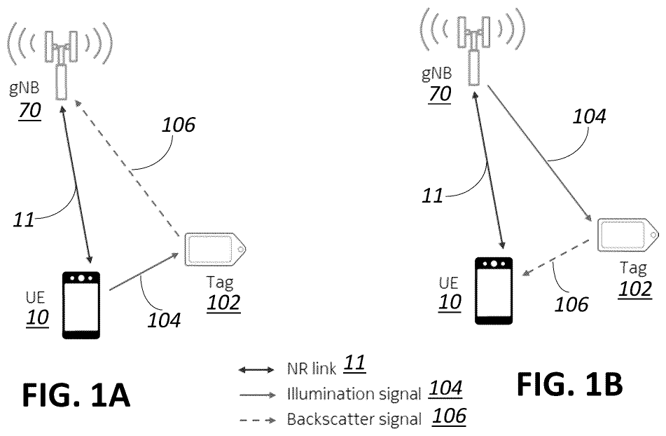

Referring to FIG. 1A and FIG. 1B, in many use cases and scenarios, passive IoT devices 102 (a.k.a. tags) are densely distributed in the user's vicinity. For example, in smart factories, IoT tags may be imbedded in machinery, tools, and sensors for operators to access instruction and data. In warehouses, IoT tags can be used to track inventory. In shopping malls and supermarkets, IoT tags can help consumers access the data about merchandize or provide direction to the desired destination.

In the coverage of an NR network, a UE 10 connected to gNB 70 can be used as a receiver of the backscatter signal 106, as shown in FIG. 1B, and/or as a transmitter of the excitation carrier (or illumination signal 104), as shown in FIG. 1A. Typically, UE 10 is not equipped with a full duplex radio, so UE 10 cannot be an excitation emitter and backscatter reader at the same time (as a monostatic passive IoT reader). In cooperation with gNB 70, however, either gNB 70 or UE 10 can transmit the excitation carrier (or illumination signal 104) to the tag 102 and the other receives the backscatter signal 106 from the tag as shown in FIG. 1A and FIG. 1B. This conforms to the bi-static architecture for passive IoT, where the excitation emitter and backscatter reader are different nodes.

For some use cases, it is better for gNB 70 to receive backscatter data (via 106) directly from the tags 102 and UE 10 provides the excitation signal 104 as shown in FIG. 1A. For example, inventory or sensor data (via 106) can be directly read by the gNB 70 while UE 10 mounted on a moving robot illuminating nearby tags 102 in different locations of a warehouse or factory. The backscatter link 106 between the gNB 70 and tag 102 for these use cases is represented by Topology (1) in the 3GPP definition.

In other use cases, e.g., shopping malls and supermarkets, the gNB 70 can provide the excitation 104 for the UE 10 to receive data (via 106) from tags 102 embedded in shelves or merchandize as shown in FIG. 1B. The backscatter link 106 between the UE 10 and tag 102 for these use cases is represented by Topology (3).

For the aforementioned use cases, where either gNB 70 or UE 10 wants to access data (via 106) from the passive tags 102 near the UE 10, the excitation carrier (or illumination signal 104) arriving at the tag 102 with sufficient amount of power is crucial. Without sufficient illumination power, the backscatter signal 106 from the tag 102 may not be received correctly by the intended reader (e.g. 10, 70), or even no modulated signal is generated as some tags 102 may modulate only if the excitation signal crosses an energy threshold. On the other hand, if the illumination power is too high, many other tags 102 may simultaneously generate different backscattered signals 106, causing interference and collisions at the reader (e.g. 10, 70). Described herein are methods and devices that help the gNB 70 or UE 10 set the appropriate illumination power and coordinates illumination signal transmission (via 104) for the desired backscatter data (via 106) to be received while constraining interference in the backscatter link.

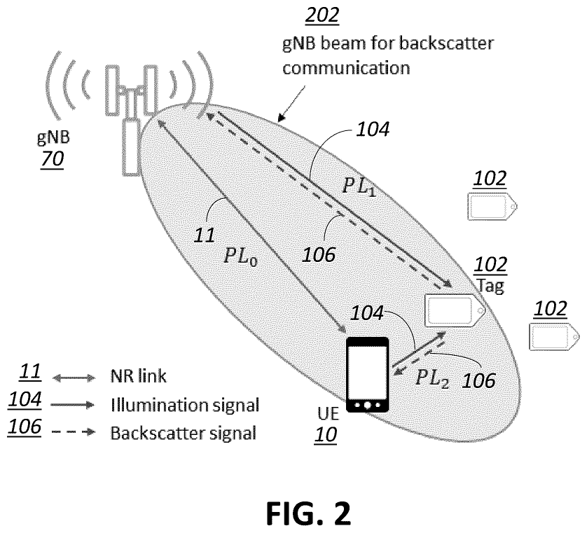

The solution is based on a tag proximity parameter configured by the network and the UE measurement in the NR system. The former defines the range of the tags from the UE and is configured according to the application and operating scenario (e.g., how close the tag is expected from the UE when the UE plans to access the tag data). The latter provides a reference for pathloss in the backscatter link. A brief summary of novelty is listed as follows using FIG. 2 for illustration. FIG. 2 shows the gNB beam 202 for backscatter communication via backscatter signal 106.

Network (NW) configures a proximity pathloss threshold η for the UE 10 such that UE-tag pathloss PL₂≤η.

gNB 70 uses UE's beam selection in NR to determine the beam direction for gNB-tag link. The backscatter link beam direction can be determined in two ways. It can be the direction of UE's strongest beam. It can also be derived from the reference signal received power (RSRP) of the best beam and its neighbor beam.

gNB uses UE's RSRP measurement to estimate gNB-tag pathloss PL₁ with this approximation PL₀≅₈ PL₁, where PL₀ is the gNB-UE pathloss.

For tags with energy storage capability (Device B type), the illumination power is a function RSRP, P_{T}=A−RSRP+η, where coefficient A can be determined from the known backscatter link characteristics and NR reference signal (RS) power density.

For tags harvesting energy from the illumination signal to power backscatter modulation (Device A type), network configures a threshold Pₜₕ for the received illumination power. The illumination power is P_{T}^{UE}=max(A−RSRP, B)+η when UE 10 is the emitter and P_{T}^{BS}=max(A+η, C)−RSRP when gNB 70 is the emitter. Coefficients B and C can be determined from the required threshold, antenna gains, reference signal (RS) power density.

The network may configure a power adjustment step ΔP and a max illumination power Pₘₐₓ or max number of illumination attempts Nₘₐₓ. If no backscatter signal 106 is received, the emitter (10, 70) retransmits illumination signal 104 with power increased by ΔP until Pₘₐₓ or Nₘₐₓ is reached.

For the applications where the tags 102 are stationary, NW may save the illumination power with UE's RSRP and beam selection in a database when backscatter signal is successfully received. This database can be queried first when setting an illumination power for a UE.

In the operating scenario, the gNB is used to either transmit the excitation carrier (or illumination signal) or receive the backscatter signal from the passive IoT devices (or tags).

To extend the range of the backscatter link, gNB may use beamforming when transmitting and receiving at the carrier wave frequency. That will not only boost the desired signal but also suppress interference in the spatial domain. However, the backscatter link may not operate at the same frequency with the NR channel. Furthermore, the antenna array and transceivers used for backscatter communication may not necessarily be the same as those for the NR system.

For our intended use cases, the tags that gNB and UE communicate with are those near the UE which is connected to the gNB in a NR network. Therefore, the UE's beam measurement (or channel state information (CSI) report) in NR is used to derive the beamforming direction for the target tags close to the UE. A simple method is using the same beam direction of the best NR beam reported by the UE. This would be a good estimate if the second best beam has a much lower RSRP since the UE is more likely to be at the center of the best beam in that case. However, if the UE is located at the edge of the best beam, the RSRP difference between the best and the second best beams would be small, and the best beam's direction may not be accurate enough for backscatter link beamforming.

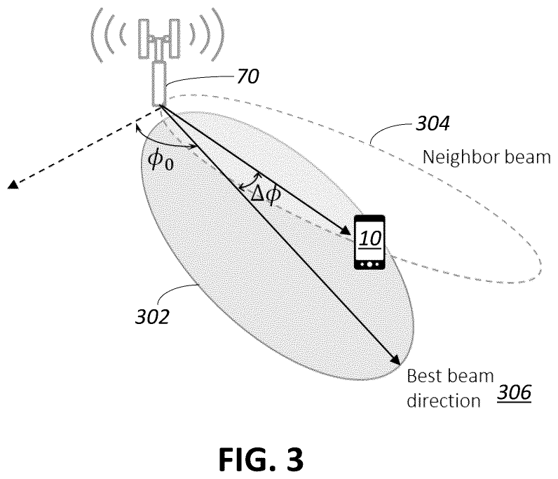

Alternatively, with reference to FIG. 3, the backscatter link's beam direction can be estimated from two NR beams (302, 304). One is the best beam 302 in terms of the reported RSRP, the other beam is the first one's stronger neighbor beam 304 (i.e., the neighbor beam 304 with the higher RSRP). A correction of angle can be applied to the best beam direction 306 based on the RSRP difference between the two beams (302, 304) or UE location information. In the azimuth domain, for example as shown in FIG. 3, a better beam direction for the UE 10 can be derived by

ϕ=ϕ₀+Δϕ,

where O₀ is the azimuth angle of the best beam 302 in UE measurement and Δϕ can be determined by the RSRP difference between the best beam 302 and the neighbor beam 304. The antenna gain difference between the two adjacent beams can be pre-calculated at various angles Δϕ in a table. Using the RSRP difference as antenna gain difference to look up the table, we can obtain a corresponding Δϕ. The same approach can be applied to the elevation angle (θ) domain to determine a new beam direction (by Δϕ) to the UE and its nearby tags. The “effective” RSRP of the new beam can be computed by adding the antenna gain difference within the angle (Δϕ, Δθ) from the beam's boresight. This revised RSRP should be used in illumination power estimation.

A new beam for the backscatter link is only relevant if the gNB uses separate antenna array or transceivers for the backscatter communication. If network has the knowledge of tags geographic distribution, gNB may use this knowledge in the beam direction estimation process, e.g., limit the beam direction in the angular domain where tags are distributed. Once the beam direction is determined, gNB can compute the beam weight for active antenna elements or select one beam from the pre-configured beam grid for the backscatter link associated with the UE. The gNB may simultaneously serve multiple backscatter links associated with different UEs if spatially separated beams are used for multiple connections.

For the estimation of illumination power, let us first consider the case where the backscatter link is in-band with the NR channel and the same antenna is used at the gNB (or BS). Referring to FIG. 2, the RSRP at the UE can be expressed as

$$RSRP = {P}_{0} + {G}_{BS} + {G}_{UE} - {PL}_{0} , \qquad ( 1 )$$

where P₀ is RS power density, G_{BS} BS's antenna gain, G_{UE} UE's antenna gain, and PL₀ the pathloss between BS and UE. For Device B type of passive tags, which does not require a power threshold for backscatter modulation, the received power at the bi-static reader is attenuated by pathloss PL₁ (between BS 70 and tag 102) and PL₂ (between tag 102 and UE 10).

If the exciter carrier is transmitted via 104 at power P_{T}, the backscatter signal is received via 106 by the reader (10, 70) with power (in dB scale)

$${P}_{R} = {P}_{T} + {G}_{UE} + {G}_{BS} + 2 {G}_{tag} - {PL}_{1} - {PL}_{2} + 10 {log}_{10} M , \qquad ( 2 )$$

where G_{tag} is the tag's antenna gain, M is backscatter modulation factor. M=0.25 for Device A type tags, and M=1 for Device B type tags [RP-230055, 3GPP TSG-RAN #99, Rotterdam, Mar. 20-23, 2023]. For the backscatter signal 106 to be received successfully, the received power P_{R} must reach the reader's sensitivity S. Note that the sensitivity will be different when gNB 70 and UE 10 is the reader.

$${P}_{T} \geq S - {G}_{UE} - {G}_{BS} - 2 {G}_{tag} + {PL}_{1} + {PL}_{2} - 10 {log}_{10} M , \qquad ( 2 )$$

For the applications where information is accessed from the tags near the UE, the network can configure a proximity parameter 11 that sets the limit of pathloss between UE and a tag, i.e., PL₂; 11. We expect the parameter 11 to cover only a short range (in the order of meters) from the UE. For a nearby tag, its path loss to gNB PL₁ can be approximated by the pathloss between gNB and UE, i.e., PL₁≈PL₀. Then the illumination power requirement in (3) can be associated with the UE's RSRP in (1) as

$${P}_{T} \geq S - 2 {G}_{tag} + {P}_{0} - RSRP + η - 10 {log}_{10} M , \qquad ( 4 )$$

considering the tag is within the range defined by parameter η. The network knows P₀ and the sensitivity and tag antenna gain can be a prior knowledge, so the coefficient A=S−2G_{tag}+P₀−10 log₁₀ M can be readily computed. And the illumination power can be set based on RSRP,

$${P}_{T} = A - RSRP + η , \qquad ( 5 )$$

to meet the sensitivity requirement at the reader.

If the tags in the use case are Device A type, they must use the power of the excitation carrier to perform backscatter modulation, and the carrier wave has to arrive at the tag with power higher than a threshold Pₜₕ [RP-230055, 3GPP TSG-RAN #99, Rotterdam, Mar. 20-23, 2023]. This would be another power requirement in addition to meeting the reader's sensitivity. The power calculation will be different when the gNB is excitation emitter and when the UE is the emitter since their pathloss to the tag is different.

When the UE is emitter, the transmit power P_{T}^{UE} must satisfy

$${P}_{T}^{U E} \geq B + η , \qquad ( 6 )$$

where the coefficient B=Pₜₕ−G_{UE}−G_{tag}. When the gNB is emitter, with the approximation PL₁≈PL₀, the transmit power P_{T}^{BS} requires

$${P}_{T}^{BS} \geq C - RSRP , \qquad ( 7 )$$

where the coefficient C=Pₜₕ+P₀+G_{UE}−G_{tag}. The coefficients B and C can be easily computed with the prior knowledge of the threshold and antenna gains and RS power density. Combined with the sensitivity requirement (5), the illumination power for Device A tags should be set to

$$\begin{matrix}{P}_{T}^{U E} = max ( A - RSRP , B ) + η , \\ {P}_{T}^{BS} = max ( A + η , C ) - RSRP ,\end{matrix} \qquad ( 8 )$$

respectively when UE or gNB is excitation emitter. Note that all variables in the calculation are in dB scale.

Now consider the case when the excitation carrier is out of band with the NR channel. The difference in path loss between the excitation carrier at frequency f₁ and the NR carrier at frequency f₂ is ΔPL=20(log₁₀ f₁−log₁₀ f₂) dB. This difference should be added to coefficients A and C. If a separate antenna array is employed at gNB for the backscatter link, the BS antenna gain (or max effective isotropic radiated power (EIRP) of the beam) between the backscatter link and NR link will generally be different. Let G_{BS,1} and G_{BS,2} be gNB's backscatter antenna gain and NR antenna gain respectively. The antenna gain difference ΔG_{BS} G_{BS,1}−G_{BS,2} should be subtracted from coefficients A and C. Likewise, if the UE has a significant difference in its antenna gain for NR and for backscatter link, the gain difference ΔG_{UE}=G_{UE,1}−G_{UE,2} should be subtracted from coefficient A, where G_{UE,1} is the UE's backscatter antenna gain and G_{UE,2} the UE's NR antenna gain.

For illumination transmission and backscatter signal reception, the gNB needs to schedule a time with the UE. This scheduling can be done in the NR system. Either gNB or UE can be illumination emitter and the other be the backscatter signal reader. Estimation of initial illumination power can be performed at gNB, or optionally at UE when the UE is excitation emitter. The initial transmit power in (5) and (8) respectively is the estimated minimum power for Device B and Device A backscattered data to be successfully received by the reader. The network can configure a power increase step ΔP. If the reader does not correctly receive the tag's data, a retry can be scheduled with the illumination power increased by ΔP. The successive increasing of power is intended to constrain unnecessary interference to other backscatter links. The network can configure either a max illumination power Pₘₐₓ or a max number of illumination attempts N_{Tx} before stopping illumination for tags near the UE.

For many applications, the passive tags are stationary, so the illumination power depends on the UE's location relative to the gNB. In this case, the network may save the used illumination power when the backscatter data is successfully received, indexed by the UE's RSRP and beam selection or the UE's location data in a database. The database can be queried first when the illumination power needs to be determined for a UE based on its RSRP/beam measurements or location. If a match can be found from the database, the saved illumination power can be directly used without going through the estimation process.

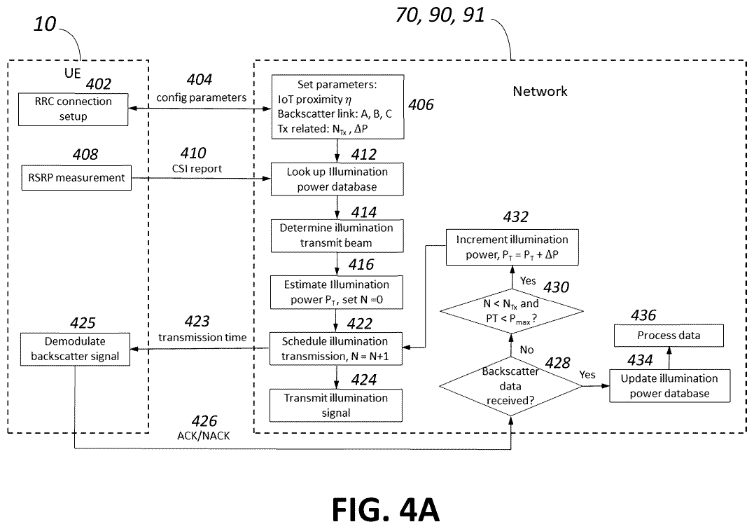

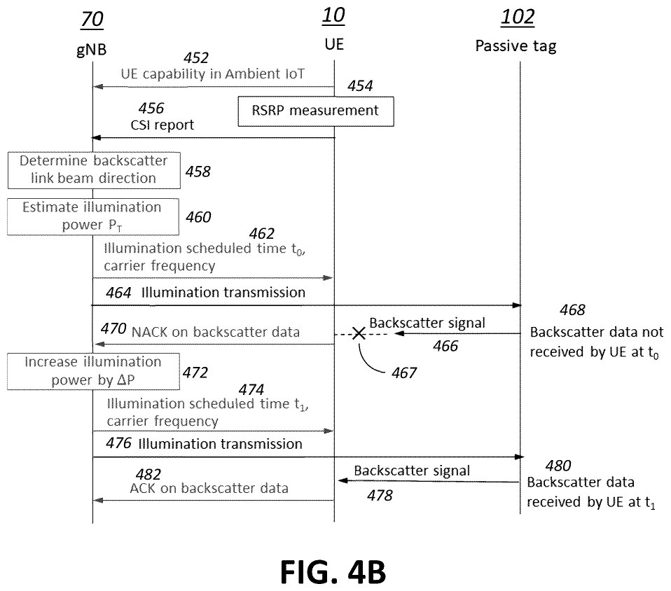

FIG. 4A shows the illumination power estimation and adjustment process for the backscatter link when the gNB 70 is excitation emitter and the UE 10 backscatter signal reader. Illumination power estimation is performed at the gNB 70 based on the configured parameters. The UE 10 needs to report its capability and parameters, e.g., supported carrier frequencies, sensitivity, and antenna gain to the network for configuration during radio resource control (RRC) connection setup, as shown in FIG. 4B. The gNB 70 estimates the initial illumination power based on the configuration and the UE's RSRP measurement in the CSI report. Then the gNB 70 schedules illumination transmission and informs the UE 10 about the scheduled time and carrier frequency on a physical downlink control channel (PDCCH) or other control channel for ambient IoT backscatter link. After the scheduled time, the UE 10 sends back an acknowledgement (ACK) or negative acknowledgement (NACK) bit on a physical uplink control channel (PUCCH), or on another uplink (UL) channel for ambient IoT data acknowledgement, as an indication of success/failure in receiving the backscatter data. In case of NACK, the gNB will schedule a retry with an increased power as described previously. The signaling flow is illustrated in FIG. 4B.

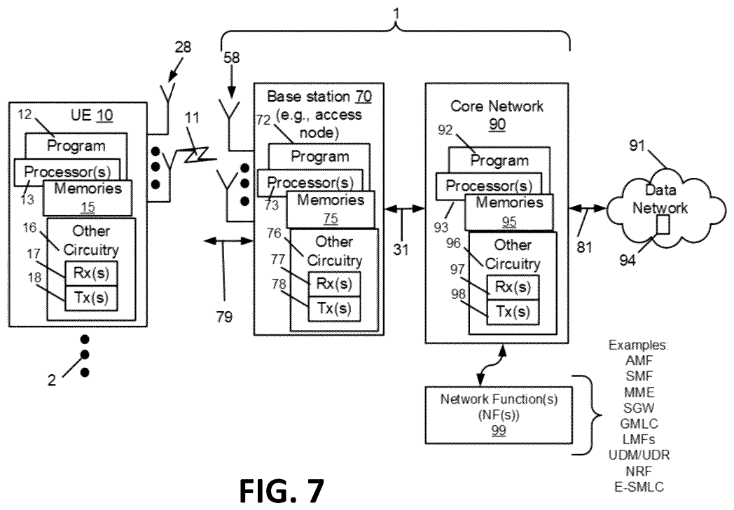

FIG. 4A shows the illumination power estimation and adjustment process including an information exchange between the UE 10 and network, which elements of the network may include gNB 70, core network 90, and data network 91 (refer to FIG. 7). As shown in FIG. 4A, during RRC connection setup 402, the UE and network exchange (at 404) configuration parameters, where at 406 the network sets parameters IoT proximity 17, backscatter link parameters including coefficients A, B, C, and transmission related parameters N_{TX} and ΔP. At 408, the UE performs RSRP measurement, and at 410 transmits a CSI report to the network. At 412, the network looks up an illumination power database.

At 414, the network determines an illumination transmit beam. At 416, the network estimates an illumination power P_{T}, and sets N=0. At 422, the network schedules illumination transmission, and sets N=N+1. At 423, the network informs the UE of the transmission time. At 424, the network transmits an illumination signal. At 425, the UE demodulates a backscatter signal. At 426, the UE transmits an acknowledgement (ACK) or negative acknowledgement (NACK) to the network, with an indication of whether or not the backscatter signal was received and/or able to be demodulated.

At 428, based on the acknowledgement or negative acknowledgement received at 426, the network determines whether the backscatter data was received. If the network determines at 428 that the backscatter data was not received (e.g. “No”), the method transitions to 430. If the network determines at 428 that the backscatter data was received (e.g. “Yes”), the method transitions to 434. At 430, the network determines whether N is less than N_{Tx} and P_{T} is less than Pₘₐₓ. If at 430 the network determines that N is less than N_{Tx} and P_{T} is less than Pₘₐₓ (e.g. “Yes”), the method transitions to 432. At 432, the network increments illumination power, setting P_{T} P_{T}+ΔP. From 432, the method transitions to 422. At 434, the network updates the illumination power database. At 436, the network processes data.

As shown in FIG. 4B, at 452 the UE 10 transmits the UE capability in ambient IoT to the gNB 70. At 454, the UE performs RSRP measurement. At 456, the UE transmits a CSI report to the gNB 70. At 458, the gNB 70 determines a backscatter link beam direction. At 460, the gNB 70 estimates illumination power P_{T}. At 462, the gNB 70 transmits to the UE 10 the illumination scheduled time to and a carrier frequency. At 464, the gNB 70 performs an illumination transmission towards the passive tag 102.

At 466, the passive tag 102 transmits a backscatter signal to the UE 10. As indicated at 467 and 468, the backscatter data associated with the backscatter signal 466 was not received by the UE 10. At 470, the UE 10 transmits to the gNB 70 a negative acknowledgement (NACK) on the backscatter data, or an indication that the backscatter data associated with the backscatter signal transmitted at 466 was not received at the scheduled time, at or around to. At 472, the gNB 70 increases illumination power by ΔP. At 474, the gNB 70 transmits to the UE 10 an illumination scheduled time t₁ and a carrier frequency. At 476, the gNB 70 transmits an illumination signal to the passive tag 102. At 478, the passive tag 102 transmits a backscatter signal to the UE 10. As indicated at 480, the backscatter data associated with the backscatter signal 478 was received by the UE 10 at time t₁. At 482, the UE 10 transmits to the gNB 70 an acknowledgement (ACK) on the backscatter data, or an indication that the backscatter data associated with the backscatter signal transmitted at 478 was received at the scheduled time, at or around t₁.

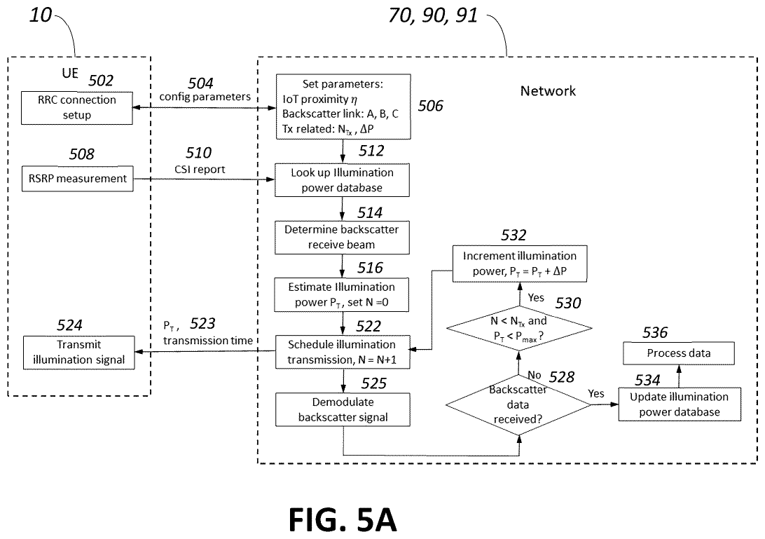

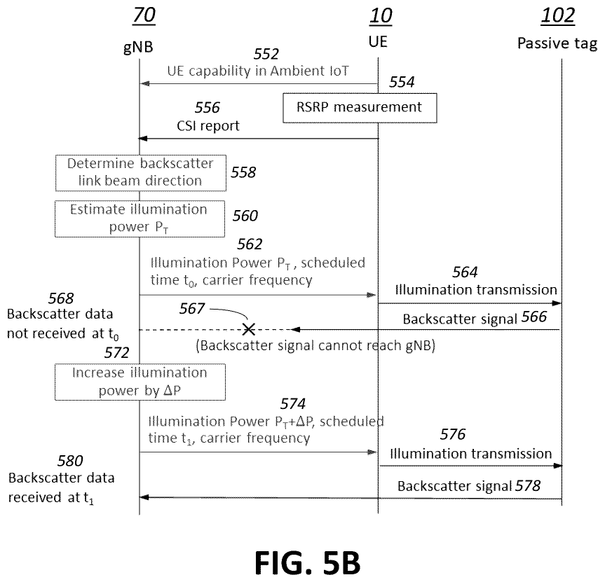

FIG. 5A shows the illumination power estimation and adjustment process when the UE is emitter and the gNB is backscatter reader and the power estimation and adjustment processes are performed by the gNB and is similar to the process shown in FIG. 4A. For each illumination occurrence, the gNB informs the UE on PDCCH about the transmit power in addition to the scheduled time and carrier frequency. The corresponding signaling flow is shown in FIG. 5B.

FIG. 5A shows the illumination power estimation and adjustment process including an information exchange between the UE 10 and network, which elements of the network may include gNB 70, core network 90, and data network 91 (refer to FIG. 7). As shown in FIG. 5A, during RRC connection setup 502, the UE and network exchange (at 504) configuration parameters, where at 506 the network sets parameters IoT proximity 17, backscatter link parameters including coefficients A, B, C, and transmission related parameters N_{TX} and ΔP. At 508, the UE performs RSRP measurement, and at 510 transmits a CSI report to the network. At 512, the network looks up an illumination power database. At 514, the network determines a backscatter receive beam. At 516, the network estimates an illumination power P_{T}, and sets N=0. At 522, the network schedules illumination transmission, and sets N=N+1. At 523, the network informs the UE of the transmission time Pₜ. At 524, the UE transmits an illumination signal. At 525, the network demodulates a backscatter signal.

At 528, the network determines whether the backscatter data was received, the backscatter data being associated with the backscatter signal. If the network determines at 528 that the backscatter data was not received (e.g. “No”), the method transitions to 530. If the network determines at 528 that the backscatter data was received (e.g. “Yes”), the method transitions to 534. At 530, the network determines whether N is less than N_{Tx} and P_{T} is less than Pₘₐₓ. If at 530 the network determines that N is less than N_{Tx} and P_{T} is less than Pₘₐₓ (e.g. “Yes”), the method transitions to 532. At 532, the network increments illumination power, setting P_{T}=P_{T}+ΔP. From 532, the method transitions to 522. At 534, the network updates the illumination power database. At 536, the network processes data (e.g. data associated with the backscatter signal).

As shown in FIG. 5B, at 552 the UE 10 transmits the UE capability in ambient IoT to the gNB 70. At 554, the UE 10 performs RSRP measurement. At 556, the UE 10 transmits a CSI report to the gNB 70. At 558, the gNB 70 determines a backscatter link beam direction. At 560, the gNB 70 estimates illumination power P_{T}. At 562, the gNB 70 transmits to the UE 10 the illumination power P_{T}, the illumination scheduled time to, and a carrier frequency. At 564, the UE 10 performs an illumination transmission towards the passive tag 102.

At 566, the passive tag 102 transmits a backscatter signal to the gNB 70. As indicated at 567 and 568, the backscatter data associated with the backscatter signal 566 was not received by the gNB 70. At 572, the gNB 70 increases illumination power by ΔP. At 574, the gNB 70 transmits to the UE 10 the illumination power P_{T}+ΔP, an illumination scheduled time t₁ and a carrier frequency. At 576, the UE 10 transmits an illumination signal to the passive tag 102. At 578, the passive tag 102 transmits a backscatter signal to the gNB 70. As indicated at 580, the backscatter data associated with the backscatter signal 578 was received by the gNB 70 at time t₁.

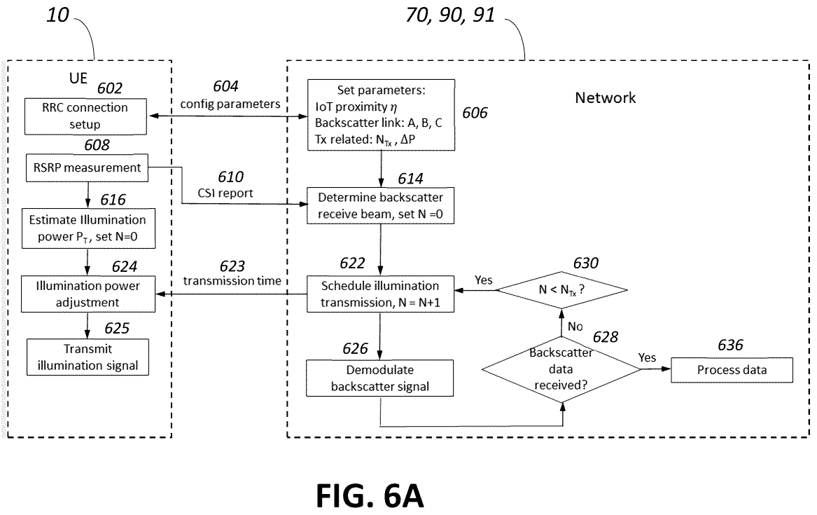

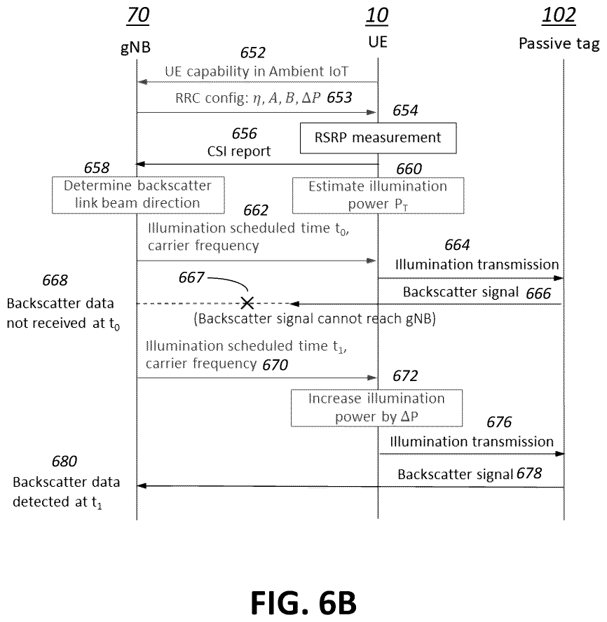

FIG. 6A shows an alternative system where the UE 10 estimates and adjusts illumination power and transmits the illumination signal (or excitation carrier). In this design, the UE needs to receive configuration parameters η, A, B, ΔP from the gNB 70 for illumination power estimation during RRC connection setup. The UE 10 uses locally measured RSRP data to estimate illumination power, but the UE's CSI report is still used by the gNB to calculate the receive beam for the backscatter link. The corresponding signaling flow is shown in FIG. 6B.

FIG. 6A shows the illumination power estimation and adjustment process including an information exchange between the UE 10 and network, which elements of the network may include gNB 70, core network 90, and data network 91 (refer to FIG. 7). As shown in FIG. 6A, during RRC connection setup 602, the UE and network exchange (at 604) configuration parameters, where at 606 the network sets parameters IoT proximity 17, backscatter link parameters including coefficients A, B, C, and transmission related parameters N_{TX} and ΔP. At 608, the UE performs RSRP measurement, and at 610 transmits a CSI report to the network. At 614, the network determines a backscatter receive beam, and sets N=0. At 616, the UE estimates an illumination power P_{T}. At 622, the network schedules illumination transmission, and sets N=N+1. At 623, the network informs the UE of the transmission time. At 624, the UE performs an illumination power adjustment. At 625, the UE transmits an illumination signal. At 626, the network demodulates a backscatter signal.

At 628, the network determines whether the backscatter data was received, the backscatter data being associated with the backscatter signal. If the network determines at 628 that the backscatter data was not received (e.g. “No”), the method transitions to 630. If the network determines at 628 that the backscatter data was received (e.g. “Yes”), the method transitions to 636. At 630, the network determines whether N is less than N_{Tx}. If at 630 the network determines that N is less than N_{Tx}, the method transitions to 622. At 636, the network processes data (e.g. data associated with the backscatter signal).

As shown in FIG. 6B, at 652 the UE 10 transmits the UE capability in ambient IoT to the gNB 70. At 653, the gNB transmits RRC configuration parameters to the UE 10, which RRC configuration parameters include η, A, B, and ΔP. At 654, the UE 10 performs RSRP measurement. At 656, the UE 10 transmits a CSI report to the gNB 70. At 658, the gNB 70 determines a backscatter link beam direction. At 660, the UE 10 estimates illumination power P_{T}. At 662, the gNB 70 transmits to the UE 10 the illumination scheduled time t₀, and a carrier frequency. At 664, the UE 10 performs an illumination transmission towards the passive tag 102.

At 666, the passive tag 102 transmits a backscatter signal to the gNB 70. As indicated at 667 and 668, the backscatter data associated with the backscatter signal 666 was not received by the gNB 70. At 670, the gNB 70 transmits to the UE 10 the illumination scheduled time t₁ and a carrier frequency. At 672, the UE 10 increases illumination power by ΔP. At 676, the UE 10 transmits an illumination signal to the passive tag 102. At 678, the passive tag 102 transmits a backscatter signal to the gNB 70. As indicated at 680, the backscatter data associated with the backscatter signal 678 was received by the gNB 70 at time t₁.

New elements described herein may include the following.

Network should configure these parameters to the gNB for illumination power estimation:
Proximity parameter η, which is application/scenario dependent
Passive IoT tag's antenna gain G_{tag}
Illumination power threshold for Device A type tags Pₜₕ
gNB's sensitivity for backscatter signal detection
Max illumination power due to hardware limit or for interference control
Max number of illumination transmissions N_{Tx}

During RRC establishment, UE needs to report its capability to gNB with these parameters:
Supported excitation carrier frequency bands
Max illumination power if UE is excitation emitter
Sensitivity for backscatter signal detection if UE is reader
Difference in antenna gain for the NR carrier and for the excitation carrier, to be used for RSRP-based pathloss estimation
Antenna gain G_{UE} if tags are Device A type.

During RRC establishment, UE receives these parameters from gNB if UE is excitation emitter and illumination power is computed at UE:
Proximity parameter η
transmit power parameters A, B
power adjustment step ΔP

Illumination signaling and acknowledgement: 1. gNB informs UE on PDCCH (or DL control channel for Ambient IoT) about the scheduled time and carrier frequency, (and power if transmission power is computed at gNB) for illumination transmission. If the UE is reader, the control channel also indicates UL resource for ACK/NACK of backscatter signal detection. 2. UE informs gNB on PUCCH (or UL control channel for Ambient IoT), ACK/NACK of backscatter signal detection when the UE is reader.

UE procedures of illumination power estimation and adjustment: When UE is excitation emitter and illumination is determined by UE, the procedures of illumination power estimation and adjustment based on RRC parameters η, A, B, ΔP.

Further aspects of the examples described herein include the gNB's determination of a transmit or receive beam for the backscatter link, the gNB's calculation of illumination power parameters A, B, and C, and the gNB's use of the illumination power database.

Some aspects described herein may be standardized, e.g., configuration of illumination power estimation and adjustment, and signaling and procedure of illumination transmission.

FIG. 7 shows a block diagram of one possible and non-limiting example of a cellular network 1 that is connected to a user equipment (UE) 10. A number of network elements are shown in the cellular network of FIG. 7: a base station 70; and a core network 90.

In FIG. 7, a user equipment (UE) 10 is in wireless communication via radio link 11 with the base station 70 of the cellular network 1. A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 is referred to as RAN node 70 herein. An example of a RAN node 70 is a gNB. There are, however, many other examples of RAN nodes including an eNB (LTE base station) or transmission reception point (TRP). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections). In the case of Wi-Fi, the link 11 could be characterized as a wireless link.

Two or more base stations 70 communicate using, e.g., link(s) 79. The link(s) 79 may be wired or wireless or both and may implement, e.g., an Xn interface for fifth generation (5G), an X2 interface for LTE, or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE network may be provided by an MME (Mobility Management Entity) and/or SGW (Serving Gateway) functionality, which routes data to the data network. Many others are possible, as illustrated by the examples in FIG. 7: AMF; SMF; MME; SGW; gateway mobile location center (GMLC); location management functions (LMFs); unified data management (UDM); unified data repository (UDR); network repository function (NRF); and/or evolved serving mobile location center (E-SMLC). These are merely exemplary core network functionality that may be provided by the core network 90, and note that both 5G and LTE core network functionality might be provided by the core network 90. The radio access network (RAN) node 70 is coupled via a backhaul link 31 to the core network 90. The RAN node 70 and the core network 90 may include an NG interface for 5G, or an S1 interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

To the extent that the description herein indicates that “cells” perform functions, but it should be clear that the base station that forms the cell will perform the functions. The cell is provided by a base station. That is, there can be multiple cells per base station. For instance, there could be three cells for a single carrier frequency and associated bandwidth, each cell covering one-third of a 360-degree area so that a single base station's coverage area covers an approximate oval, circle, or other shape. Furthermore, each cell can correspond to a single carrier and a base station may use multiple carriers. So, if there are three 120-degree cells per carrier and two carriers, then the base station has a total of six cells.

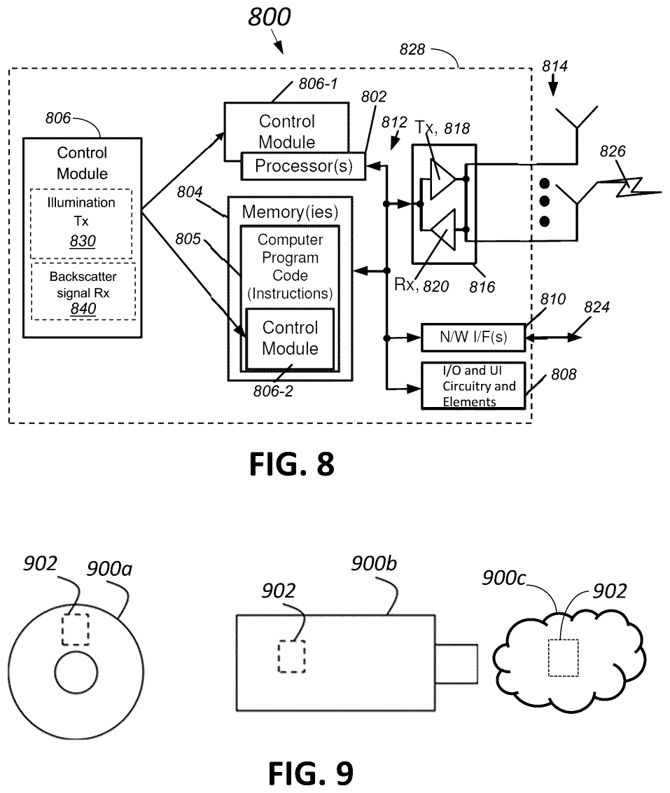

FIG. 8 is an example apparatus 800, which may be implemented in hardware, configured to implement the examples described herein. The apparatus 800 comprises at least one processor 802 (e.g. a field programmable gate array (FPGA) and/or central processing unit (CPU)), one or more memories 804 including computer program code 805, the computer program code 805 having instructions to carry out the methods described herein, wherein the at least one memory 804 and the computer program code 805 are configured to, with the at least one processor 802, cause the apparatus 800 to implement circuitry, a process, component, module, or function (implemented with control module 806) to implement the examples described herein, including passive IoT illumination transmission and power setting. The memory 804 may be a non-transitory memory, a transitory memory, a volatile memory (e.g. random access memory (RAM)), or a non-volatile memory (e.g. read-only memory (ROM)).

The apparatus 800 includes a display and/or input/output (I/O) interface 808, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 800 includes one or more communication e.g. network (N/W) interfaces (I/F(s)) 810. The communication I/F(s) 810 may be wired and/or wireless and communicate over the Internet/other network(s) via any communication technique including via one or more links 824. The link(s) 824 may be the connection(s) 11 and/or 79 and/or 31 and/or 81 from FIG. 1. The communication I/F(s) 810 may comprise one or more transmitters or one or more receivers.

The transceiver 816 comprises one or more transmitters 818 and one or more receivers 820. The transceiver 816 and/or communication I/F(s) 810 may include components such as an amplifier, filter, frequency-converter, (de)modulator, and encoder/decoder circuitries and one or more antennas, such as antennas 814 used for communication over wireless link 826.

The control module 806 of the apparatus 800 comprises one of or both parts 806-1 and/or 806-2, which may be implemented in a number of ways. The control module 806 may be implemented in hardware as control module 806-1, such as being implemented as part of the one or more processors 802. The control module 806-1 may be implemented also as an integrated circuit or through other hardware such as a programmable gate array. In another example, the control module 806 may be implemented as control module 806-2, which is implemented as computer program code (having corresponding instructions) 805 and is executed by the one or more processors 802. For instance, the one or more memories 804 store instructions that, when executed by the one or more processors 802, cause the apparatus 800 to perform one or more of the operations as described herein. Furthermore, the one or more processors 802, the one or more memories 804, and example algorithms (e.g., as flowcharts and/or signaling diagrams), encoded as instructions, programs, or code, are means for causing performance of the operations described herein.

Optionally included illumination Tx 830 of the control module 806 may be used to transmit the illumination signal 104 to the tag 102 as described herein, and optionally included backscatter signal Rx may be used to receive the backscatter signal 106 from the tag 102 as described herein. The control module 806 may be used for other purposes such as functionality described in FIG. 4A, FIG. 4B, FIG. 5A, FIG. 5B, FIG. 6A, and FIG. 6B.

The apparatus 800 to implement the functionality of control 806 may be UE 10, base station 70 (e.g. gNB 70), or core network 90. Thus, processor 802 may correspond to processor(s) 13, processor(s) 73 and/or processor(s) 93, memory 804 may correspond to one or more memories 15, one or more memories 75 and/or one or more memories 95, computer program code 805 may correspond to program 12, program 72, or program 92, communication I/F(s) 810 and/or transceiver 816 may correspond to other circuitry 16, other circuitry 76, or other circuitry 96, and antennas 814 may correspond to antennas 28 or antennas 58.

Alternatively, apparatus 800 and its elements may not correspond to either of UE 10, base station 70, or core network and their respective elements, as apparatus 800 may be part of a self-organizing/optimizing network (SON) node or other node, such as a node in a cloud.

The apparatus 800 may also be distributed throughout the network (e.g. 100) including within and between apparatus 800 and any network element (such as core network 90 and/or the base station 70 and/or the UE 10).

Interface 812 enables data communication and signaling between the various items of apparatus 800, as shown in FIG. 8. For example, the interface 812 may be one or more buses such as address, data, or control buses, and may include any interconnection mechanism, such as a series of lines on a motherboard or integrated circuit, fiber optics or other optical communication equipment, and the like. Computer program code (e.g. instructions) 805, including control 806 may comprise object-oriented software configured to pass data or messages between objects within computer program code 805. The apparatus 800 need not comprise each of the features mentioned, or may comprise other features as well. The various components of apparatus 800 may at least partially reside in a common housing 828, or a subset of the various components of apparatus 800 may at least partially be located in different housings, which different housings may include housing 828.

FIG. 9 shows a schematic representation of non-volatile memory media 900a (e.g. computer/compact disc (CD) or digital versatile disc (DVD)) and 900b (e.g. universal serial bus (USB) memory stick) and 900c (e.g. cloud storage for downloading or emailing instructions and/or parameters 902 or for receiving emailed instructions and/or parameters 902) storing instructions and/or parameters 902 which when executed by a processor allows the processor to perform one or more of the steps of the methods described herein.

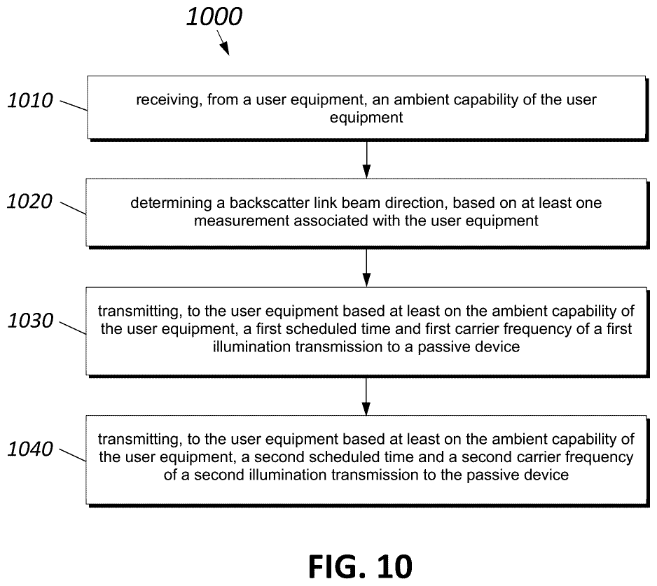

FIG. 10 is an example method 1000, based on the example embodiments described herein. At 1010, the method includes receiving, from a user equipment, an ambient capability of the user equipment. At 1020, the method includes determining a backscatter link beam direction, based on at least one measurement associated with the user equipment.

At 1030, the method includes transmitting, to the user equipment based at least on the ambient capability of the user equipment, a first scheduled time and first carrier frequency of a first illumination transmission to a passive device. At 1040, the method includes transmitting, to the user equipment based at least on the ambient capability of the user equipment, a second scheduled time and a second carrier frequency of a second illumination transmission to the passive device. Method 1000 may be performed with base station 70 (e.g. gNB 70) or apparatus 800.

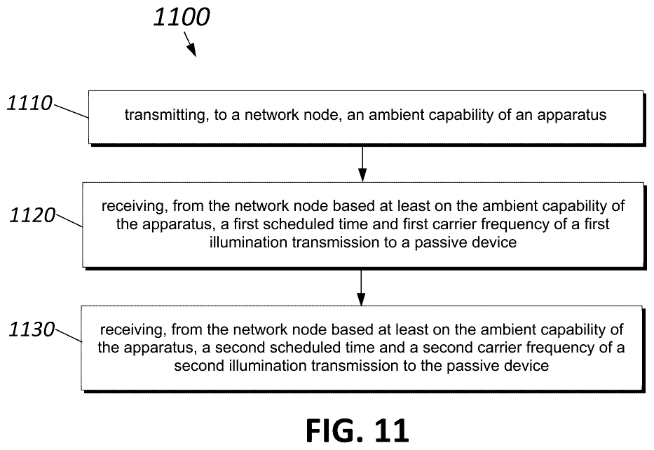

FIG. 11 is an example method 1100, based on the example embodiments described herein. At 1110, the method includes transmitting, to a network node, an ambient capability of an apparatus. At 1120, the method includes receiving, from the network node based at least on the ambient capability of the apparatus, a first scheduled time and first carrier frequency of a first illumination transmission to a passive device. At 1130, the method includes receiving, from the network node based at least on the ambient capability of the apparatus, a second scheduled time and a second carrier frequency of a second illumination transmission to the passive device. Method 1100 may be performed with UE 10 or apparatus 800.

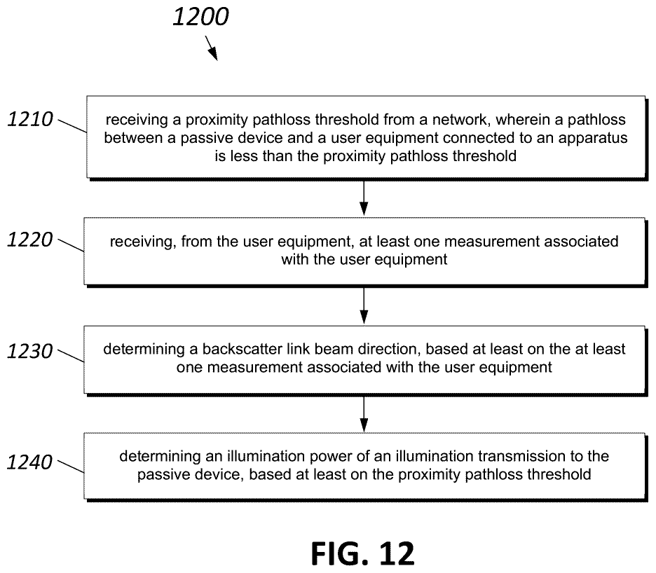

FIG. 12 is an example method 1200, based on the example embodiments described herein. At 1210, the method includes receiving a proximity pathloss threshold from a network, wherein a pathloss between a passive device and a user equipment connected to an apparatus is less than the proximity pathloss threshold. At 1220, the method includes receiving, from the user equipment, at least one measurement associated with the user equipment. At 1230, the method includes determining a backscatter link beam direction, based at least on the at least one measurement associated with the user equipment. At 1240, the method includes determining an illumination power of an illumination transmission to the passive device, based at least on the proximity pathloss threshold. Method 1000 may be performed with base station 70 (e.g. gNB 70) or apparatus 800.

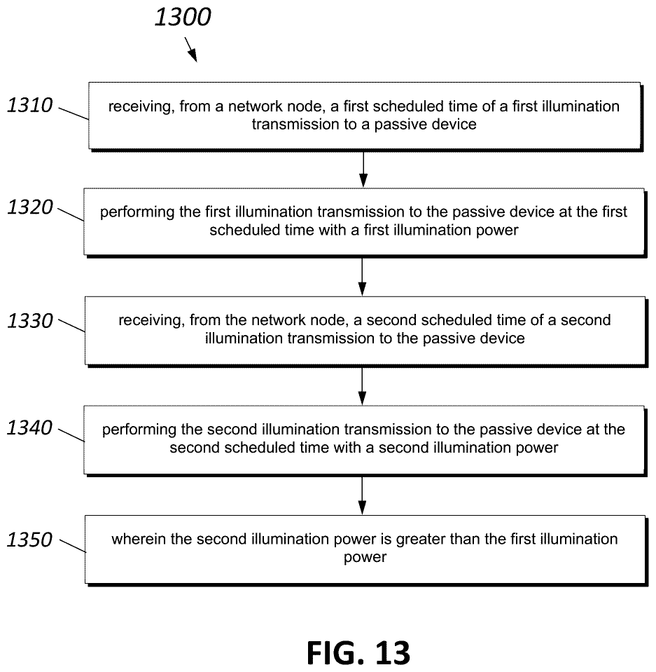

FIG. 13 is an example method 1300, based on the example embodiments described herein. At 1310, the method includes receiving, from a network node, a first scheduled time of a first illumination transmission to a passive device. At 1320, the method includes performing the first illumination transmission to the passive device at the first scheduled time with a first illumination power. At 1330, the method includes receiving, from the network node, a second scheduled time of a second illumination transmission to the passive device. At 1340, the method includes performing the second illumination transmission to the passive device at the second scheduled time with a second illumination power. At 1350, the method includes wherein the second illumination power is greater than the first illumination power. Method 1300 may be performed with UE 10 or apparatus 800.

The following examples are provided and described herein.

Example 1. An apparatus including: means for receiving, from a user equipment, an ambient capability of the user equipment; means for determining a backscatter link beam direction, based on at least one measurement associated with the user equipment; means for transmitting, to the user equipment based at least on the ambient capability of the user equipment, a first scheduled time and first carrier frequency of a first illumination transmission to a passive device; and means for transmitting, to the user equipment based at least on the ambient capability of the user equipment, a second scheduled time and a second carrier frequency of a second illumination transmission to the passive device.

Example 2. The apparatus of example 1, further including means for receiving, from the user equipment during radio resource control establishment, at least one parameter related to the ambient capability of the user equipment, the at least one parameter comprising: supported excitation carrier frequency bands, or an upper limit of an illumination power when the user equipment is an excitation emitter, or a sensitivity for backscatter signal detection when the user equipment is a reader of a backscatter signal, or a difference in antenna gain for a radio carrier and an excitation carrier, the difference in antenna gain configured to be used for reference signal received power based pathloss estimation, or an antenna gain when the passive device has no energy storage.

Example 3. The apparatus of any of examples 1 to 2, further including: means for estimating an illumination power of the first illumination transmission.

Example 4. The apparatus of example 3, further including means for receiving a configuration of at least one parameter configured to be used to estimate the illumination power of the first illumination transmission, wherein the least one parameter comprises at least: a proximity pathloss threshold, wherein a pathloss between the user equipment and the passive device is less than or equal to the proximity pathloss threshold, or an antenna gain of the passive device, or a modulation factor of the passive device, or a received illumination power threshold for the passive device, wherein the passive device has no energy storage, or a sensitivity of the apparatus for backscatter signal detection, or an upper limit of the illumination power due to a hardware limit or for interference control, or an upper limit of a number of illumination transmissions.

Example 5. The apparatus of any of examples 3 to 4, further including: means for performing the first illumination transmission to the passive device at the first scheduled time with the first carrier frequency, based on the estimated illumination power; means for receiving, from the user equipment, an acknowledgement that indicates that backscatter data associated with the first illumination transmission at the first scheduled time was received; means for receiving, from the user equipment, a negative acknowledgement that indicates that backscatter data associated with the first illumination transmission at the first scheduled time was not received; means for increasing the illumination power by an amount based on a power adjustment value; means for performing the second illumination transmission to the passive device at the second scheduled time with the second carrier frequency, based on the increase of the illumination power, in response to receiving the negative acknowledgement; and means for receiving, from the user equipment, an acknowledgement that indicates that backscatter data associated with the second illumination transmission at the second scheduled time was received.

Example 6. The apparatus of example 5, further including: means for receiving, from the user equipment, the acknowledgement that indicates that backscatter data associated with the first illumination transmission at the first scheduled time was received, the acknowledgement that indicates that backscatter data associated with the second illumination transmission at the second scheduled time was received, and the negative acknowledgement on: a physical uplink control channel, or an uplink control channel for ambient internet of things.

Example 7. The apparatus of example 6, further including: means for transmitting, to the user equipment on a physical downlink control channel, an indication of an uplink resource to use for the acknowledgement that indicates that backscatter data associated with the first illumination transmission at the first scheduled time was received, the acknowledgement that indicates that backscatter data associated with the second illumination transmission at the second scheduled time was received, and the negative acknowledgement; wherein the uplink resource comprises the physical uplink control channel, or the uplink control channel for ambient internet of things.

Example 8. The apparatus of any of examples 3 to 7, further including: means for transmitting, to the user equipment, the estimated illumination power; means for determining that backscatter data associated with the first illumination transmission at the first scheduled time was not received by the apparatus; means for increasing the illumination power by an amount based on a power adjustment value; means for transmitting, to the user equipment, the illumination power that was increased by the amount, wherein the illumination power that was increased by the amount is associated with the second illumination transmission to the passive device; and means for determining that backscatter data associated with the second illumination transmission at the second scheduled time was received by the apparatus.

Example 9. The apparatus of example 8, further including: means for transmitting, to the user equipment, the estimated illumination power and the illumination power that was increased by the amount on: a physical downlink control channel, or a downlink control channel for ambient internet of things.

Example 10. The apparatus of any of examples 1 to 9, further including means for transmitting, to the user equipment, parameters during a radio resource control configuration, the parameters comprising: a proximity pathloss threshold, wherein a pathloss between the user equipment and the passive device is less than or equal to the proximity pathloss threshold, a first coefficient, a second coefficient, and a power adjustment value; wherein the parameters are configured to be used by the user equipment to determine illumination power of illumination transmission to the passive device; wherein the parameters are transmitted to the user equipment when the apparatus is a target of reception of a backscatter signal associated with the first illumination transmission and the second illumination transmission.

Example 11. The apparatus of any of examples 1 to 10, further including: means for transmitting, to the user equipment, the first scheduled time and first carrier frequency of the first illumination transmission to the passive device, and the second scheduled time and the second carrier frequency of the second illumination transmission to the passive device on: a physical downlink control channel, or a downlink control channel for ambient internet of things.

Example 12. An apparatus including: means for transmitting, to a network node, an ambient capability of the apparatus; means for receiving, from the network node based at least on the ambient capability of the apparatus, a first scheduled time and first carrier frequency of a first illumination transmission to a passive device; and means for receiving, from the network node based at least on the ambient capability of the apparatus, a second scheduled time and a second carrier frequency of a second illumination transmission to the passive device.

Example 13. The apparatus of example 12, further including means for transmitting, to the network node during radio resource control establishment, at least one parameter related to the ambient capability of the apparatus, the at least one parameter comprising: supported excitation carrier frequency bands, or an upper limit of an illumination power when the apparatus is an excitation emitter, or a sensitivity for backscatter signal detection when the apparatus is a reader of a backscatter signal, or a difference in antenna gain for a radio carrier and an excitation carrier, the difference in antenna gain configured to be used for reference signal received power based pathloss estimation, or an antenna gain when the passive device has no energy storage.

Example 14. The apparatus of any of examples 12 to 13, further including: means for estimating an illumination power of the first illumination transmission; means for performing the first illumination transmission to the passive device at the first scheduled time with the first carrier frequency, based on the estimated illumination power; means for increasing the illumination power of the illumination transmission by an amount based on a power adjustment value, in response to receiving the second scheduled time and the second carrier frequency from the network node; and means for performing the second illumination transmission to the passive device at the second scheduled time with the second carrier frequency, based on the illumination power that has been increased.

Example 15. The apparatus of any of examples 12 to 14, further including: means for receiving, from the network node, an estimated illumination power of the first illumination transmission; means for performing the first illumination transmission to the passive device at the first scheduled time with the first carrier frequency, based on the estimated illumination power; means for receiving, from the network node, an illumination power of the second illumination transmission, wherein the illumination power of the second illumination transmission has been increased by an amount based on a power adjustment value; and means for performing the second illumination transmission to the passive device at the second scheduled time with the second carrier frequency, based on the illumination power that has been increased by the amount based on the power adjustment value.

Example 16. The apparatus of any of examples 12 to 15, further including: means for determining that backscatter data associated with the first illumination transmission at the first scheduled time was received by the apparatus; means for transmitting, to the network node, an acknowledgement that indicates that the backscatter data associated with the first illumination transmission at the first scheduled time was received by the apparatus; means for determining that backscatter data associated with the first illumination transmission at the first scheduled time was not received by the apparatus; means for transmitting, to the network node, a negative acknowledgement that indicates that the backscatter data associated with the first illumination transmission at the first scheduled time was not received by the apparatus; means for determining that backscatter data associated with the second illumination transmission at the second scheduled time was received by the apparatus; and means for transmitting, to the network node, an acknowledgement that indicates that the backscatter data associated with the second illumination transmission at the second scheduled time was received by the apparatus.

Example 17. The apparatus of example 16, further including: means for transmitting, to the network node, the acknowledgement that indicates that the backscatter data associated with the first illumination transmission at the first scheduled time was received, the acknowledgement that indicates that the backscatter data associated with the second illumination transmission at the second scheduled time was received, and the negative acknowledgement on: a physical uplink control channel, or an uplink control channel for ambient internet of things.

Example 18. The apparatus of example 17, further including: means for receiving, from the network node on a physical downlink control channel, an indication of an uplink resource to use for the acknowledgement that indicates that the backscatter data associated with the first illumination transmission at the first scheduled time was received, the acknowledgement that indicates that the backscatter data associated with the second illumination transmission at the second scheduled time was received, and the negative acknowledgement; wherein the uplink resource comprises the physical uplink control channel, or the uplink control channel for ambient internet of things.

Example 19. The apparatus of any of examples 12 to 18, further including means for receiving, from the network node, parameters during a radio resource control configuration, the parameters comprising: a proximity pathloss threshold, a first coefficient, a second coefficient, and a power adjustment value; wherein the parameters are configured to be used by the apparatus to estimate an illumination power of illumination transmission to the passive device; wherein the parameters are received from the network node when the apparatus estimates an illumination power of the first illumination transmission to the passive device and determines an illumination power of the second illumination transmission to the passive device, and when the apparatus performs the first illumination transmission to the passive device at the first scheduled time and the second illumination transmission to the passive device at the second scheduled time.

Example 20. The apparatus of any of examples 12 to 19, further including: means for receiving, from the network node, the first scheduled time and first carrier frequency of the first illumination transmission to the passive device, and the second scheduled time and the second carrier frequency of the second illumination transmission to the passive device on: a physical downlink control channel, or a downlink control channel for ambient internet of things; and means for receiving, from the network node, an illumination power associated with the first illumination transmission, and an illumination power that has been increased and that is associated with the second illumination transmission on: a physical downlink control channel, or a downlink control channel for ambient internet of things.

Example 21. An apparatus including: at least one processor; and at least one memory storing instructions that, when executed by the at least one processor, cause the apparatus at least to: receive, from a user equipment, an ambient capability of the user equipment; determine a backscatter link beam direction, based on at least one measurement associated with the user equipment; transmit, to the user equipment based at least on the ambient capability of the user equipment, a first scheduled time and first carrier frequency of a first illumination transmission to a passive device; and transmit, to the user equipment based at least on the ambient capability of the user equipment, a second scheduled time and a second carrier frequency of a second illumination transmission to the passive device.

Example 22. An apparatus including: at least one processor; and at least one memory storing instructions that, when executed by the at least one processor, cause the apparatus at least to: transmit, to a network node, an ambient capability of the apparatus; receive, from the network node based at least on the ambient capability of the apparatus, a first scheduled time and first carrier frequency of a first illumination transmission to a passive device; and receive, from the network node based at least on the ambient capability of the apparatus, a second scheduled time and a second carrier frequency of a second illumination transmission to the passive device.

Example 23. A method including: receiving, from a user equipment, an ambient capability of the user equipment; determining a backscatter link beam direction, based on at least one measurement associated with the user equipment; transmitting, to the user equipment based at least on the ambient capability of the user equipment, a first scheduled time and first carrier frequency of a first illumination transmission to a passive device; and transmitting, to the user equipment based at least on the ambient capability of the user equipment, a second scheduled time and a second carrier frequency of a second illumination transmission to the passive device.

Example 24. A method including: transmitting, to a network node, an ambient capability of an apparatus; receiving, from the network node based at least on the ambient capability of the apparatus, a first scheduled time and first carrier frequency of a first illumination transmission to a passive device; and receiving, from the network node based at least on the ambient capability of the apparatus, a second scheduled time and a second carrier frequency of a second illumination transmission to the passive device.

Example 25. A non-transitory program storage device readable by a machine, tangibly embodying a program of instructions executable by the machine for performing operations, the operations including: receiving, from a user equipment, an ambient capability of the user equipment; determining a backscatter link beam direction, based on at least one measurement associated with the user equipment; transmitting, to the user equipment based at least on the ambient capability of the user equipment, a first scheduled time and first carrier frequency of a first illumination transmission to a passive device; and transmitting, to the user equipment based at least on the ambient capability of the user equipment, a second scheduled time and a second carrier frequency of a second illumination transmission to the passive device.

Example 26. A non-transitory program storage device readable by a machine, tangibly embodying a program of instructions executable by the machine for performing operations, the operations including: transmitting, to a network node, an ambient capability of an apparatus; receiving, from the network node based at least on the ambient capability of the apparatus, a first scheduled time and first carrier frequency of a first illumination transmission to a passive device; and receiving, from the network node based at least on the ambient capability of the apparatus, a second scheduled time and a second carrier frequency of a second illumination transmission to the passive device.

Example 27. An apparatus including: means for receiving a proximity pathloss threshold from a network, wherein a pathloss between a passive device and a user equipment connected to the apparatus is less than the proximity pathloss threshold; means for receiving, from the user equipment, at least one measurement associated with the user equipment; means for determining a backscatter link beam direction, based at least on the at least one measurement associated with the user equipment; and means for determining an illumination power of an illumination transmission to the passive device, based at least on the proximity pathloss threshold.

Example 28. The apparatus of example 27, further including: means for receiving, from the user equipment, a report that indicates a beam of the user equipment having a higher reference signal received power than at least one other beam of the user equipment; and means for determining the backscatter link beam direction, based on a direction of the beam of the user equipment having a higher reference signal received power than at least one other beam of the user equipment.

Example 29. The apparatus of any of examples 27 to 28, further including: means for determining the backscatter link beam direction, based on a reference signal received power of a first beam of the user equipment and a reference signal received power of a neighbor beam of the user equipment; wherein the reference signal received power of the first beam is higher than a reference signal received power of at least one neighbor beam of the user equipment including the neighbor beam.

Example 30. The apparatus of example 29, further including: means for determining whether a distance between the user equipment and an edge of the first beam is less than or equal to a distance threshold; and means for determining the backscatter link beam direction, based on the reference signal received power of the first beam of the user equipment and the reference signal received power of the neighbor beam of the user equipment, when the distance between the user equipment and the edge of the first beam is less than or equal to the distance threshold.

Example 31. The apparatus of any of examples 29 to 30, further including: means for determining a first angle based on the first beam; means for determining a difference between the reference signal received power of the first beam and the reference signal received power of the neighbor beam; means for determining a correction angle to apply to the first angle, based on the difference; and means for determining the backscatter link beam direction, based on the correction angle applied to the first angle; wherein the first angle and the correction angle are in an azimuth domain or an elevation domain.

Example 32. The apparatus of any of examples 29 to 31, further including: means for determining a first angle based on the first beam; means for determining location information associated with the user equipment; means for determining a correction angle to apply to the first angle, based on the location information associated with the user equipment; and means for determining the backscatter link beam direction, based on the correction angle applied to the first angle; wherein the first angle and the correction angle are in an azimuth domain or an elevation domain.

Example 33. The apparatus of any of examples 27 to 32, further including: means for determining a pathloss between the apparatus and the user equipment, based on a reference signal received power of the user equipment; means for determining a pathloss between the apparatus and the passive device, based at least on the pathloss between the apparatus and the user equipment; and means for determining the illumination power based at least partially on the pathloss between the apparatus and the passive device.

Example 34. The apparatus of any of examples 27 to 33, further including: means for determining a coefficient based on at least one known backscatter link characteristic and a reference signal power density; and means for determining the illumination power, based on the coefficient.

Example 35. The apparatus of example 34, wherein the at least one known backscatter link characteristic comprises at least one of: a sensitivity of a reader of a backscatter signal, or an antenna gain of the passive device, or a backscatter modulation factor.

Example 36. The apparatus of example 35, further including: means for determining the coefficient at least based on the sensitivity of the reader of the backscatter signal, the antenna gain of the passive device, and the backscatter modulation factor.

Example 37. The apparatus of any of examples 34 to 36, further including: means for determining a reference signal received power of the user equipment; and means for determining the illumination power at least partially based on the reference signal received power.

Example 38. The apparatus of any of examples 27 to 37, further including: means for determining, when the passive device has no energy storage, a received power threshold of the passive device, such that a carrier wave arrives at the passive device with a power greater than the received power threshold.

Example 39. The apparatus of example 38, further including: means for determining a first coefficient based on at least one known backscatter link characteristic and a reference signal power density; means for determining a reference signal received power of the user equipment; means for determining a second coefficient based at least on the received power threshold of the passive device and one known backscatter link characteristic; and means for determining the illumination power based on the first coefficient, the reference signal received power, and the second coefficient.

Example 40. The apparatus of example 39, further including: means for determining a difference between the first coefficient and the reference signal received power; means for determining the illumination power based on the proximity pathloss threshold added to a larger of the difference and the second coefficient, when the user equipment performs the illumination transmission to the passive device.

Example 41. The apparatus of example 40, further including: means for determining the second coefficient based on an antenna gain of the user equipment and an antenna gain of the passive device, wherein the one known backscatter link characteristic comprises the antenna gain of the passive device.

Example 42. The apparatus of any of examples 39 to 41, further including: means for determining a sum comprising the first coefficient added to the proximity pathloss threshold; means for determining the illumination power based on the reference signal received power subtracted from a larger of the sum and the second coefficient, when the apparatus performs the illumination transmission to the passive device.

Example 43. The apparatus of example 42, further including: means for determining the second coefficient based on the reference signal power density, an antenna gain of the user equipment, and an antenna gain of the passive device, wherein the one known backscatter link characteristic comprises the antenna gain of the passive device.

Example 44. The apparatus of any of examples 27 to 43, further including: means for storing a used illumination power, a reference signal received power of a user equipment, and a beam selection of a user equipment in a database; and means for retrieving from the database at least one of: the used illumination power, or the reference signal received power of the user equipment, or the beam selection of the user equipment; wherein the illumination power of the illumination transmission to the passive device is determined based on at least one of the used illumination power, or the reference signal received power of the user equipment, or the beam selection of the user equipment retrieved from the database.

Example 45. The apparatus of example 44, further including: means for determining whether a backscatter signal was received; wherein the used illumination power, or the reference signal received power of the user equipment, or the beam selection of a user equipment is stored in the database when the backscatter signal was received.

Example 46. The apparatus of any of examples 44 to 45, further including: means for determining whether the passive device is stationary; wherein the used illumination power, or the reference signal received power of the user equipment, or the beam selection of a user equipment is stored in the database when the passive device is stationary.

Example 47. An apparatus including: means for receiving, from a network node, a first scheduled time of a first illumination transmission to a passive device; means for performing the first illumination transmission to the passive device at the first scheduled time with a first illumination power; means for receiving, from the network node, a second scheduled time of a second illumination transmission to the passive device; and means for performing the second illumination transmission to the passive device at the second scheduled time with a second illumination power; wherein the second illumination power is greater than the first illumination power.

Example 48. The apparatus of example 47, further including: means for determining the first illumination power and the second illumination power.

Example 49. The apparatus of example 47, further including: means for receiving, from the network node, the first illumination power; and means for receiving, from the network node, the second illumination power.

Example 50. An apparatus including: at least one processor; and at least one memory storing instructions that, when executed by the at least one processor, cause the apparatus at least to: receive a proximity pathloss threshold from a network, wherein a pathloss between a passive device and a user equipment connected to the apparatus is less than the proximity pathloss threshold; receive, from the user equipment, at least one measurement associated with the user equipment; determine a backscatter link beam direction, based at least on the at least one measurement associated with the user equipment; and determine an illumination power of an illumination transmission to the passive device, based at least on the proximity pathloss threshold.

Example 51. An apparatus including: at least one processor; and at least one memory storing instructions that, when executed by the at least one processor, cause the apparatus at least to: receive, from a network node, a first scheduled time of a first illumination transmission to a passive device; perform the first illumination transmission to the passive device at the first scheduled time with a first illumination power; receive, from the network node, a second scheduled time of a second illumination transmission to the passive device; and perform the second illumination transmission to the passive device at the second scheduled time with a second illumination power; wherein the second illumination power is greater than the first illumination power.

Example 52. A method including: receiving a proximity pathloss threshold from a network, wherein a pathloss between a passive device and a user equipment connected to an apparatus is less than the proximity pathloss threshold; receiving, from the user equipment, at least one measurement associated with the user equipment; determining a backscatter link beam direction, based at least on the at least one measurement associated with the user equipment; and determining an illumination power of an illumination transmission to the passive device, based at least on the proximity pathloss threshold.

Example 53. A method including: receiving, from a network node, a first scheduled time of a first illumination transmission to a passive device; performing the first illumination transmission to the passive device at the first scheduled time with a first illumination power; receiving, from the network node, a second scheduled time of a second illumination transmission to the passive device; and performing the second illumination transmission to the passive device at the second scheduled time with a second illumination power; wherein the second illumination power is greater than the first illumination power.

Example 54. A non-transitory program storage device readable by a machine, tangibly embodying a program of instructions executable by the machine for performing operations, the operations including: receiving a proximity pathloss threshold from a network, wherein a pathloss between a passive device and a user equipment connected to an apparatus is less than the proximity pathloss threshold; receiving, from the user equipment, at least one measurement associated with the user equipment; determining a backscatter link beam direction, based at least on the at least one measurement associated with the user equipment; and determining an illumination power of an illumination transmission to the passive device, based at least on the proximity pathloss threshold.

Example 55. A non-transitory program storage device readable by a machine, tangibly embodying a program of instructions executable by the machine for performing operations, the operations including: receiving, from a network node, a first scheduled time of a first illumination transmission to a passive device; performing the first illumination transmission to the passive device at the first scheduled time with a first illumination power; receiving, from the network node, a second scheduled time of a second illumination transmission to the passive device; and performing the second illumination transmission to the passive device at the second scheduled time with a second illumination power; wherein the second illumination power is greater than the first illumination power.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific integrated circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment.

Accordingly, this description is intended to embrace all such alternatives, modifications and variances which fall within the scope of the appended claims.

1. An apparatus comprising:
at least one processor; and at least one memory storing instructions that, when executed by the at least one processor, cause the apparatus at least to:
receive a proximity pathloss threshold from a network, wherein a pathloss between a passive device and a user equipment connected to the apparatus is less than the proximity pathloss threshold;
receive, from the user equipment, at least one measurement associated with the user equipment;
determine a backscatter link beam direction, based at least on the at least one measurement associated with the user equipment; and
determine an illumination power of an illumination transmission to the passive device, based at least on the proximity pathloss threshold.

2. The apparatus of claim 1, wherein the instructions, when executed by the at least one processor, cause the apparatus at least to:
receive, from the user equipment, a report that indicates a beam of the user equipment having a higher reference signal received power than at least one other beam of the user equipment; and
determine the backscatter link beam direction, based on a direction of the beam of the user equipment having a higher reference signal received power than at least one other beam of the user equipment.

3. The apparatus of claim 1, wherein the instructions, when executed by the at least one processor, cause the apparatus at least to:
determine the backscatter link beam direction, based on a reference signal received power of a first beam of the user equipment and a reference signal received power of a neighbor beam of the user equipment;
wherein the reference signal received power of the first beam is higher than a reference signal received power of at least one neighbor beam of the user equipment including the neighbor beam.

4. The apparatus of claim 3, wherein the instructions, when executed by the at least one processor, cause the apparatus at least to:
determine whether a distance between the user equipment and an edge of the first beam is less than or equal to a distance threshold; and
determine the backscatter link beam direction, based on the reference signal received power of the first beam of the user equipment and the reference signal received power of the neighbor beam of the user equipment, when the distance between the user equipment and the edge of the first beam is less than or equal to the distance threshold.

5. The apparatus of claim 3, wherein the instructions, when executed by the at least one processor, cause the apparatus at least to:
determine a first angle based on the first beam;
determine a difference between the reference signal received power of the first beam and the reference signal received power of the neighbor beam;
determine a correction angle to apply to the first angle, based on the difference; and
determine the backscatter link beam direction, based on the correction angle applied to the first angle;
wherein the first angle and the correction angle are in an azimuth domain or an elevation domain.

6. The apparatus of claim 3, wherein the instructions, when executed by the at least one processor, cause the apparatus at least to:
determine a first angle based on the first beam;
determine location information associated with the user equipment;
determine a correction angle to apply to the first angle, based on the location information associated with the user equipment; and
determine the backscatter link beam direction, based on the correction angle applied to the first angle;
wherein the first angle and the correction angle are in an azimuth domain or an elevation domain.

7. The apparatus of claim 1, wherein the instructions, when executed by the at least one processor, cause the apparatus at least to:
determine a pathloss between the apparatus and the user equipment, based on a reference signal received power of the user equipment;
determine a pathloss between the apparatus and the passive device, based at least on the pathloss between the apparatus and the user equipment; and
means for determining the illumination power based at least partially on the pathloss between the apparatus and the passive device.

8. The apparatus of claim 1, wherein the instructions, when executed by the at least one processor, cause the apparatus at least to:
determine a coefficient based on at least one known backscatter link characteristic and a reference signal power density; and
determine the illumination power, based on the coefficient.

9-11. (canceled)

12. The apparatus of claim 1, wherein the instructions, when executed by the at least one processor, cause the apparatus at least to:
determine, when the passive device has no energy storage, a received power threshold of the passive device, such that a carrier wave arrives at the passive device with a power greater than the received power threshold.

13. The apparatus of claim 12, wherein the instructions, when executed by the at least one processor, cause the apparatus at least to:
determine a first coefficient based on at least one known backscatter link characteristic and a reference signal power density;
determine a reference signal received power of the user equipment;
determine a second coefficient based at least on the received power threshold of the passive device and one known backscatter link characteristic; and
determine the illumination power based on the first coefficient, the reference signal received power, and the second coefficient.

14. The apparatus of claim 13, wherein the instructions, when executed by the at least one processor, cause the apparatus at least to:
determine a difference between the first coefficient and the reference signal received power;
determine the illumination power based on the proximity pathloss threshold added to a larger of the difference and the second coefficient, when the user equipment performs the illumination transmission to the passive device.

15. The apparatus of claim 14, wherein the instructions, when executed by the at least one processor, cause the apparatus at least to:
determine the second coefficient based on an antenna gain of the user equipment and an antenna gain of the passive device, wherein the one known backscatter link characteristic comprises the antenna gain of the passive device.

16. The apparatus of claim 13, wherein the instructions, when executed by the at least one processor, cause the apparatus at least to:
determine a sum comprising the first coefficient added to the proximity pathloss threshold;
determine the illumination power based on the reference signal received power subtracted from a larger of the sum and the second coefficient, when the apparatus performs the illumination transmission to the passive device.

17. The apparatus of claim 16, wherein the instructions, when executed by the at least one processor, cause the apparatus at least to:
determine the second coefficient based on the reference signal power density, an antenna gain of the user equipment, and an antenna gain of the passive device, wherein the one known backscatter link characteristic comprises the antenna gain of the passive device.

18. The apparatus of claim 1, wherein the instructions, when executed by the at least one processor, cause the apparatus at least to:
store a used illumination power, a reference signal received power of a user equipment, and a beam selection of a user equipment in a database; and
retrieve from the database at least one of: the used illumination power, or the reference signal received power of the user equipment, or the beam selection of the user equipment;
wherein the illumination power of the illumination transmission to the passive device is determined based on at least one of the used illumination power, or the reference signal received power of the user equipment, or the beam selection of the user equipment retrieved from the database.

19. The apparatus of claim 18, wherein the instructions, when executed by the at least one processor, cause the apparatus at least to:
determine whether a backscatter signal was received;
wherein the used illumination power, or the reference signal received power of the user equipment, or the beam selection of a user equipment is stored in the database when the backscatter signal was received.

20. The apparatus of claim 18, wherein the instructions, when executed by the at least one processor, cause the apparatus at least to:
determine whether the passive device is stationary;
wherein the used illumination power, or the reference signal received power of the user equipment, or the beam selection of a user equipment is stored in the database when the passive device is stationary.

21. A method comprising:
receiving, from a network node, a first scheduled time of a first illumination transmission to a passive device;
performing the first illumination transmission to the passive device at the first scheduled time with a first illumination power;
receiving, from the network node, a second scheduled time of a second illumination transmission to the passive device; and
performing the second illumination transmission to the passive device at the second scheduled time with a second illumination power;
wherein the second illumination power is greater than the first illumination power.

22. The method of claim 21, further comprising:
determining the first illumination power and the second illumination power.

23. The method of claim 21, further comprising:
receiving, from the network node, the first illumination power; and
receiving, from the network node, the second illumination power.
